(19) United States
(12) Patent Application Publication
(10) Pub. No.: US 2016/0016381 A1
(43) Pub. Date: Jan. 21, 2016

(54) Fire Restrictive Material

(71) Applicant: Jorge Enrique Celis Marin, Medellín (CO)

(72) Inventor: Jorge Enrique Celis Marin, Medellín (CO)

(21) Appl. No.: 14/334,575

(22) Filed: Jul. 17, 2014

(51) Int. Cl. B32B 5/26; B32B 7/12; B32B 5/02; C09D 5/18

(52) U.S. Cl. CPC B32B 5/26; C09D 5/185; B32B 7/12; B32B 5/022; B32B 5/024; B32B 2250/05; B32B 2250/40; B32B 2255/02; B32B 2307/3065

(57) ABSTRACT

A fire resistant material having boards of the same nature on the upper and lower section of a board core that useful in the manufacture of vessels and other high fire risk is provided. The core board may be made of polyurethane foam, polypropylene or a metal, preferably aluminum while the external boards adhered to the core board are made of aleatory nonwoven sheets adhered to a woven fiber sheet. External or outmost surfaces of the material are further cover with a continued and uniform intumescent paint coating.

### TECHNICAL FIELD OF THE INVENTION

This invention relates to fire restrictive materials. More particular, the invention is directed to fire restrictive material, useful in the manufacture of vessels and/or other high fire risk objects.

### BACKGROUND OF THE INVENTION

Fire may be devastating on a vessel, particularly on passenger ships, where large numbers of people may need to be evacuated. The nature of the materials used in the manufacture of sections of a vessel that by its own nature has a higher fire risk or hazard is one of the most important factors considered in avoiding or drastically reducing fire hazards. For instance, bulkheads nearby or surrounding machine rooms, kitchen areas and electronic elements such as the control and command consoles must be manufactured with fire-restrictive materials in order to avoid or reduce the fire risk or hazard.

The instant invention is directed to a fire restrictive material having a low density, firmness and resistance to external forces that is ideal for the manufacture of vessels and/or other high fire risk objects.

### OBJECTS AND SUMMARY OF THE INVENTION

It is an object of the invention to provide a fire resistance material having high resistance to external forces or impacts and useful in the construction of vessels and other high fire risk objects. It is another object of the invention to provide a material with a low density, a high strength and stiffness. Another object of the invention is to provide different embodiments of fire restrictive material having variable mechanical resistance, thus the mechanical resistance required in the object to be manufactured may be properly matched with the mechanical resistance of the particular embodiment of the fire-restrictive material used to manufacture such object.

The foregoing and other objects, features and advantages of the instant invention will appear more fully herein after from a consideration of the detailed description that follows, in conjunctions with the accompanying drawings. It is point out, however, that should be understood that the drawings are included for illustrative purposes and are not to be construed as defining the limits of the invention.

### BRIEF DESCRIPTION OF THE DRAWINGS

The foregoing and additional features and characteristics of the present invention will become more apparent from the following detailed description considered with reference to the accompanying drawings, wherein:

FIG. 1 shows a diagrammatical representation in a perspective view of one embodiment of the fire-restrictive material according to the invention.

FIG. 2 illustrates a diagrammatical representation in an exploded view of the fire restrictive material according to the invention showed in FIG. 1 illustrating its components individually.

FIG. 3 shows a diagrammatical representation in a perspective view of the laminate comprising fibers sheets illustrated with numerals 16, 17, 31 and 32 in FIGS. 2 and/or 8.

FIG. 4 illustrates a diagrammatical representation in an exploded view of the three fibers sheets included in the manufacture of the laminate showed in FIG. 3.

FIGS. 5 and 6 show a diagrammatical representation in perspective view of the two types of fiber sheets illustrated in FIG. 4.

FIG. 7 illustrates a diagrammatical representation, in a perspective view of another embodiment of the fire restrictive material according to the instant invention.

FIG. 8 illustrates a diagrammatical representation in an exploded view of the embodiment according to the invention showed in FIG. 3, illustrating its components individually.

FIGS. 9 through 12 illustrate examples of different core board used according to the invention:

FIG. 9 shows a diagrammatical representation in perspective view of a type of core board used according to the invention having a compact structure.

FIG. 10 shows a diagrammatical representation in perspective view of a type of core board used according to the invention having a reticulated honeycomb shaped structure and closed cell units.

FIG. 11 shows a diagrammatical representation in perspective view of a type of core board used according to the invention having a reticulated honeycomb shaped structure and open cell units.

FIG. 12 shows a diagrammatical representation in perspective view of a type of core board used according to the invention having a reticulated honeycomb shaped structure and compact cell units.

### DETAILED DESCRIPTION OF THE EMBODIMENTS

The following detailed description illustrates the invention and a variety of embodiments by way of example and is not limited to the particular limitations presented herein as principles of the invention. This description is directed to enable one skilled in the art to make and use the invention by describing embodiments, adaptations, variations and alternatives of the invention. Any potential variations of the limitations herein described are within the scope of the invention.

In general terms, the instant invention is directed to a fire-restrictive material, which is highly suitable for the manufacture of sections of high fire hazard vessels. For instance, the control and command consoles. The instant disclosed material may also be used in the manufacture of other high fire risk objects at the discretion of the user with the clear intention to provided vessels and other objects with excellent resistance to fire, fumes and other secondary hazardous conditions produced by a combination process.

The instant invention comprises different embodiments having variable mechanical resistance by increasing the number of external boards as explained below. In this manner, the proper embodiment may be selective in order to manufacture a given object or section of a given object depending on the mechanical resistance required in a particular section to be manufactured with the herein disclosed fire restrictive material.

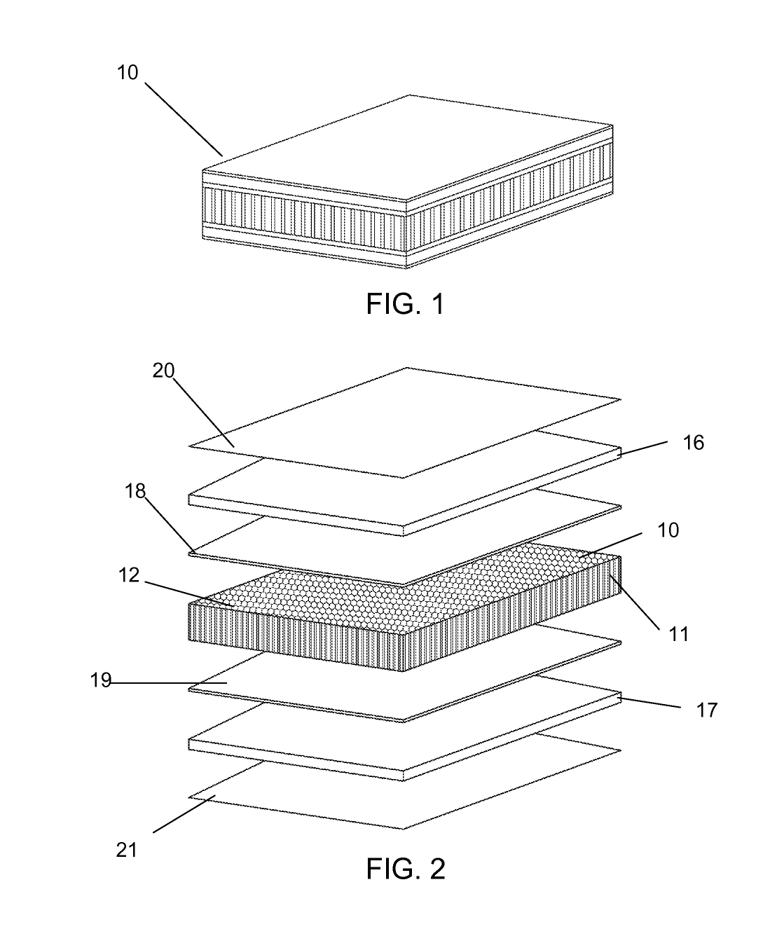

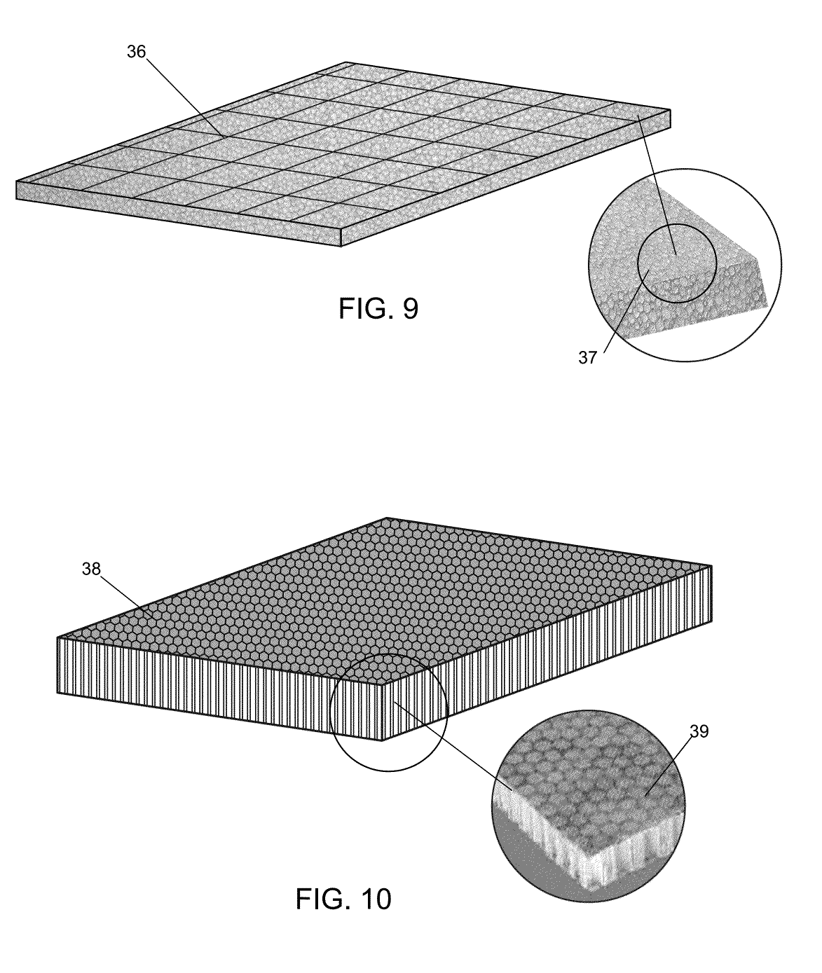

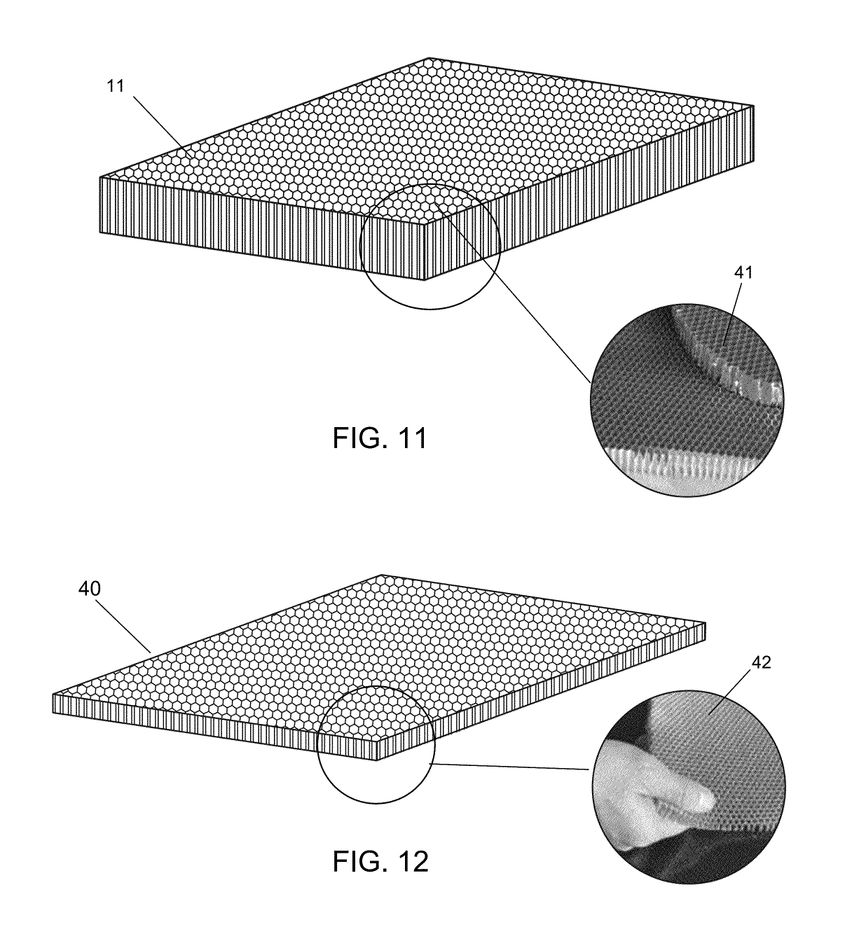

A first embodiment of the invention 10 is illustrated in the perspective view illustrated diagrammatically in FIG. 1. An exploded view of said embodiment 10, showing the different components that it comprises individually is illustrated in FIG. 2. As illustrated in FIGS. 1 and 2, embodiment 10 comprises a centered core board 11, having an upper surface 12 and a lower surface 14 (not illustrated). For illustrative purposes, core board 11 is represented in FIGS. 1 and 2 as having a honeycomb structure with open cells, nonetheless it is pointed out that said core board 11 may have any other suitable structure and it may be made of a variety of suitable materials known in the art. Thus, core board 11 according to the instant invention may be made of polyurethane foam, polypropylene or a suitable metal, preferably aluminum. Furthermore, it structure may be compact, reticulated or a honeycomb shape. Said core board 11 may be manufactured by any methods known in the art. In a preferably variation of embodiment 10, core board 11 is made of multiple thin layers of aluminum adhesively joined and having a honeycomb structure since it has been shown that such core board type has a higher resistance against forces directed to the perpendicular position of the center of the core board 11. In any of the embodiments within the scope of the fire restrictive material herein disclosed, the core board 11 is preferably to have the large thickness in reference to any other of the required boards. Its main purpose is providing stiffness to the fire restrictive material 10 without a significant increase in the weight of the material 10 due to its low density. The presence of multiple cavities, which may be full of air or any other suitable gas in the structure of core board 11 decreases its density. Core boards 11 having a honeycomb configuration are isotropic, thus allowing a grater resistance at the perpendicular position of the core board 11. According to the instant invention, core board 11 has a prefer density range of 1-8 lb. per ft3 and a preferable thickness range between 0.5 to 2 inches. Particular examples of preferable core board 11 used in the manufacture of fire-restrictive material 10 are further discussed below and are illustrated in FIGS. 9 through 12.

As illustrated in FIGS. 1 and 2, fire-restrictive material in embodiment 10 also comprises one set of external boards 16 and 17, which are identical in shape, constitution and structure. External board 16 is adhered to the core board 11 at its upper surface 12 while external board 17 is adhered to the lower surface 14 of the core board 11 via continued and uniform coats or layers of adhesive material 18 and 19, respectively. External boards 16 and 17 according to the present invention have a preferably density range of 2 to 18 lb./m2 and a prefer thickness range between of 1/32 to ¼ in. Similarly, adhesive coats 18 and 19 have a preferred thickness range of 1/32 to 1/16 in.

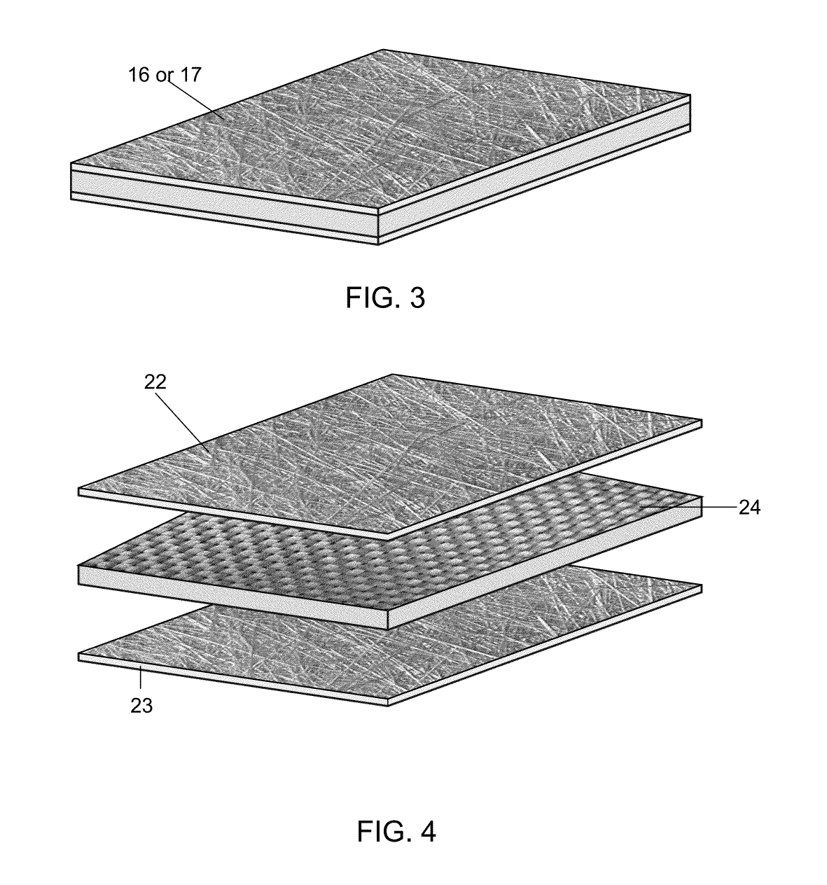

More particularly, FIGS. 3 and 4 illustrate the detailed composition the external boards 16 or 17, which, as mentioned before, are identical. Each of said external boards comprises three same size and continued fibers sheets 22, 23 and 24. Fiber sheets 22 and 23 are identical and as illustrated in FIG. 4, fiber sheet 22 is positioned on top of fiber sheet 24 while fiber sheet 23 is positioned under fiber sheet 24. Each one of fiber sheets 22 and 23 comprises multiple fibers spread in an aleatory or random distribution, thus forming a nonwoven mat or chopped strand mat. Said nonwoven mat may be made of fiber glass, carbon fibers, para-aramid synthetic fibers or any other similar or suitable and known fibers or potential combinations thereof, which are impregnated with catalyzed resins. Aleatory fiber sheets 22 or 23 may be made by any suitable and known method in the art, said methods usually comprising impregnating the corresponding fibers with a suitable resinoid bond material over a flat surface. Each aleatory fiber sheets 22 and 23 allows the absorption of an extraordinary amount of resin, up to 2.5 times its own weight. The preferably density range of each of said sheets 22 or 23 for the manufacture of fire-restrictive material according to the instant invention is from 0.3 to 1.0 lb./ft2 while its preferably thickness range is 1/32 to 1/16 in.

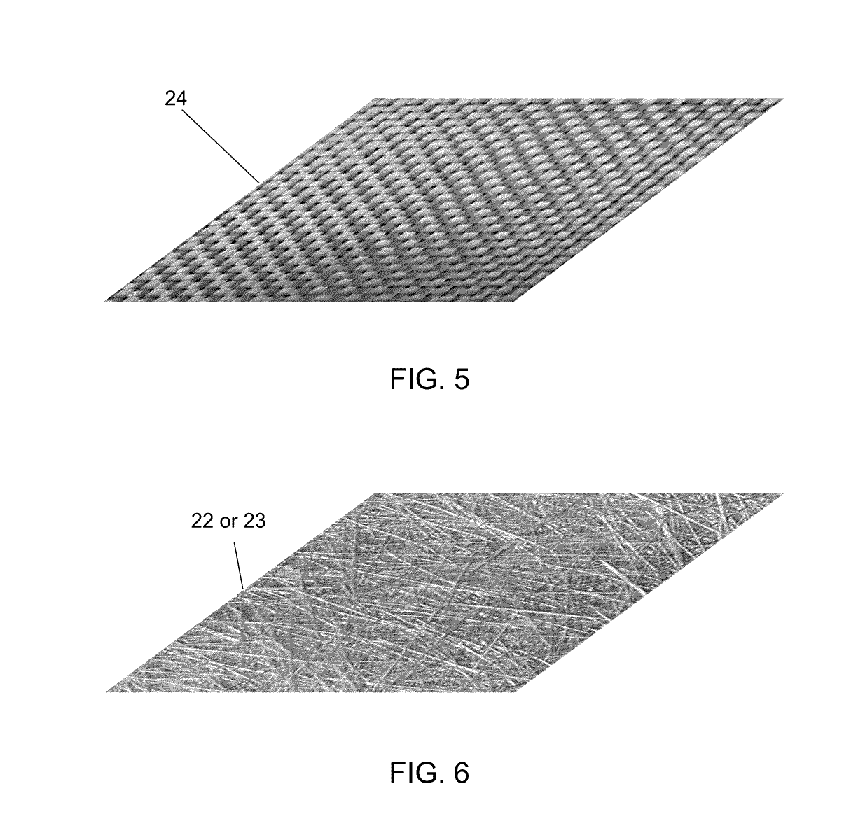

Regarding fiber sheet 24, it must be positioned in the middle of aleatory sheets 22 and 23 and it comprises an organized woven fiber structure, preferably fiber glass, carbon fiber, para-aramid synthetic fibers or any other similar or suitable and known fibers or potential combinations thereof, intertwined in a bidirectional position for example, woven roving or intertwined in a tridimensional manner. Intertwined fiber sheet 24 may be made by any suitable known process such as extrusion. Woven sheet 24 provides resin absorption of near 1.8 its own weight. According to the instant invention the required woven sheet 24 has a preferred density range of 0.3 to 1.0 lb. /m2 and a preferred thickness range of 1/32 to 1/16 in. Both type of fiber sheets: nonwoven aleatory 22 or 23 and intertwined 24 are shown in FIGS. 5 and 6.

In order to provide external board 16 or 17, fiber sheets 22, 23 and 24 are adhered in the ordered position as illustrated in FIGS. 3 and 4 by any suitable method. For instance, they may be adhered to each other via a vacuum assisted manual process, wherein each one of the sheets 22, 23 and 24 is impregnated with catalyzed resin and once impregnated; each sheet is positioned on top of other, following the illustrated or in the already mentioned order while resting over a planar surface. The resulting external board 16 or 17 is allowed to rest until it is cure and ready to be used in the manufacture of the fire restrictive material 10 by adhering external board 16 over to the core board 11 at its upper surface 12 while external board 17 is adhered to the lower surface 14 of the core board 11 via continued and uniform layers of adhesive material 18 and 19, respectively. In those instances wherein core board 11 has closed cells, a uniform and continue coat of the same catalyzed resin used to join fibers sheets 22, 23 and 24 may be used as an adhesive material in order to adhere external boards 17 and 18 to the core board 11. On the other hand, whenever core board 11 comprises an open cell structure, the adhesive material used is preferably an epoxy based adhesive, that may contain fire retardant additives, increasing the resistant of material 10 to high temperatures. The adhesive material coats 18 and 19 are applied as a uniform continued layer covering the entire surfaces to which they are being adhered. More particularly, the corresponding surface of the external board is coated with the adhesive material and then positioned on the respective surface of the core board 11. The adhered boards are covered with a plastic sheet and allowed to cure under vacuum conditions. The process is repeated with the second surface of the board core 11, thus providing the proper joining of boards 16, 11 and 17.

Once external boards 16 and 17 are adhered to the core board 11, continued and uniform coats of intumescent paint 20 and 21 are applied on the outward surfaces of the external boards 16 and 17. The application of coats 20 and 21 may be made by any suitable method known in the art, but more preferably by means of a suitable spray gun system, which allows a better control of the painting rate and uniform paint distribution. According to the instant invention, intumescent paint coats 20 and 21 may have prefer density range of 2.8 to 3.0 lb./m3 and a prefer thickness range of 1/32 to ⅛ in. Once the arrangement according to the invention is ready, it is cut in predetermined sizes depending on the dimensions of the parts or sections wherein it will be used.

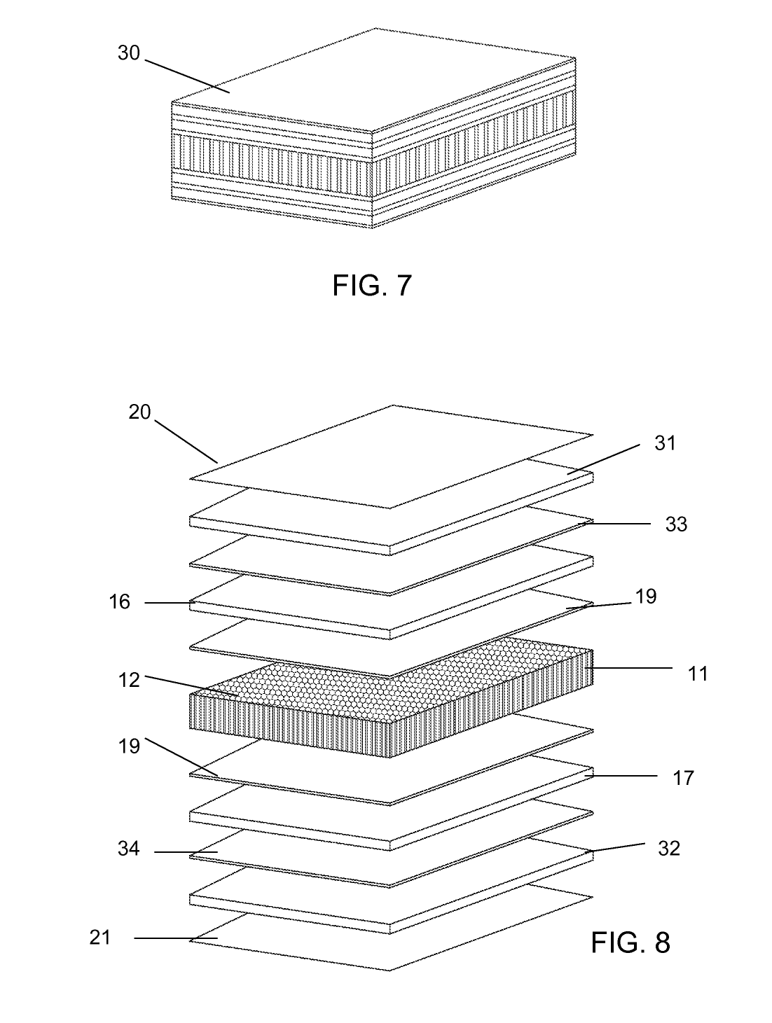

In other embodiments of the invention, the amount of external boards may be increased, preferably by adding a predetermined amount of said extra external boards to the external boards 16 and/or 17, which are already adhered to the core board 11. More preferably, extra external boards may be added on predetermined pairs, by adhering each one of the extra pair of external boards to the outmost surface of each one of the first pair of external boards 16 and 17 which are adhered to the core board 11, and following the same process of adhering the following pair of external boards on the outmost surface of the outer external board. An example of said embodiment type is embodiment 30, illustrated on FIGS. 7 and 8. Embodiment 30 comprises an extra set of external boards 31 and 32 wherein external board 31 is adhered to external board 16 while external board 32 is adhered to external board 17 by means of a uniform and continued adhesive coat 33 and 34, respectively. Core bore 11 having open cell units in a honeycomb pattern is included in FIGS. 7 and 8, nonetheless, any other type of core board may be substituted in said embodiment 30, just as previously indicated regarding embodiment 10. The increase the amounts of external boards increases the mechanical resistance of the material, providing a fire restrictive materials similar to embodiment 10 but with a higher mechanical resistance. In this manner, the mechanical resistance of the material herein disclosed may be match with the required mechanical resistance required for a particular vessel sections- or the mechanical resistance of a given high fire risk objects-to be manufactured with the herein disclosed fire restrictive material.

Similarly, the same details, principles and limitations and preferred characteristics previously indicated for each one of the individual sections already discussed for embodiment 10 also apply for embodiment 30.

Regarding the core board required in the instant invention, it may have different structures. For instance, core board 36, illustrated in FIG. 9, has unit cells 37 compacted. Similarly, core board 38, illustrated in FIG. 10 has is unit cells arranged in honeycomb structure wherein the cells units 39 are closed. Core bore 11 and 40 have a honeycomb structure with its unit cells 41 and 42 being open.

While the invention has been described in conjunction with some embodiments, it is to be understood that many alternatives, modifications, and variations will be apparent to those skilled in the art in light of the forgoing description. Accordingly, the invention is intended to embrace all such alternatives, modifications and variations falling within the spirit and scope of the appended claims.

What it is claim is:

1. A fire-restrictive material useful as construction material in the manufacture of vessels and other fire sensitive objects, said material comprising:
a) a core board;
b) a first external board;
c) a second external board, said second external board being identical to the first external board;
d) a first coat of adhesive material, adhering the lower surface of the first external board to the upper surface of the core board;
e) a second coat of adhesive material, adhering the upper surface of the second external board to the lower surface of the core board;
f) first coat of intumescent paint applied to the upper surface of said first exterior board;
g) a second coat of intumescent paint applied on the lower surface of the second external board and;
wherein each one of said first and second external boards comprises:
a woven fiber sheet having its fibers intertwined;
a first nonwoven fiber sheet having its fibers distributed in an aleatory manner,
said first nonwoven fiber sheet being adhered to the upper surface of the woven sheet;
a second nonwoven fiber sheet having its fibers having its fibers distributed in an aleatory manner, said first nonwoven fiber sheet being adhered to the lower surface of the woven sheet.

2. The material as recited in claim 1, wherein the thickness of the core board is preferably larger than the thickness of the first or second external boards.

3. The material as recited in claim 1, wherein the core board is made of polyurethane foam, polypropylene or a metal.

4. The arrangement as recited in claim 3, wherein the core board is made of aluminum.

5. A fire-restrictive material, useful as construction material in the manufacture of vessels and other fire sensitive objects, said material comprising:
h) a core board;
i) a first external board;
j) a second external board, said second external board being identical to the first external board;
k) a first coat of adhesive material, adhering the lower surface of the first external board to the upper surface of the core board;
l) a second coat of adhesive material, adhering the upper surface of the second external board to the lower surface of the core board;
m) a predetermined numbers of extra external boards adhered on top of the first external board and the second external board
n) first coat of intumescent paint applied to the upper surface of the outmost exterior board;
o) a second coat of intumescent paint applied on the lower surface of the outmost external board and;
wherein each one any of said external boards comprises:
a woven fiber sheet having its fibers intertwined;
a first nonwoven fiber sheet having its fibers having its fibers distributed in an aleatory manner, said first nonwoven fiber sheet being adhered to the upper surface of the woven sheet;
a second nonwoven fiber sheet having its fibers having its fibers distributed in an aleatory manner, said first nonwoven fiber sheet being adhered to the lower surface of the woven sheet.

6. The material as recited in claim 5, wherein the thickness of the core board is larger than the thickness of the first or second external boards.

7. The material as recited in claim 5, wherein the core board is made of polyurethane foam, polypropylene or a metal.

8. The material as recited in claim 7, wherein the core board is made of aluminum.
